(19) United States
(12) Patent Application Publication
(10) Pub. No.: US 2004/0016365 A1
(43) Pub. Date: Jan. 29, 2004

(54) Pigment-based black ink

(75) Inventors: In-Shan Sir, Kaohsiung (TW); Yu-Chang Shen, Taipei (TW); Yu-Ting Lin, Lujou City (TW)

Correspondence Address: Richard P. Berg, Esq., c/o LADAS & PARRY, Suite 2100, 5670 Wilshire Boulevard, Los Angeles, CA, 90036-5679, US

(73) Assignee: BENQ CORPORATION

(21) Appl. No.: 10/622,979

(22) Filed: Jul. 17, 2003

(30) Foreign Application Priority Data
Jul. 23, 2002 (TW) 91116344

(51) Int. Cl. C09D 11/00; G01D 11/00

(52) U.S. Cl. 106/31.6; 106/31.65; 106/31.86; 347/100

(57) ABSTRACT

A pigment-based black ink. The ink includes a carbon black pigment dispersions, macromolecular chromophores (MMCs), and an aqueous solution medium. The black ink of the present invention combines a carbon black pigment dispersions and a MMCs and has a higher optical density than ink including only carbon black pigment dispersions or MMCs

### BACKGROUND OF THE INVENTION

1. Field of the Invention

The present invention relates to a pigment-based black ink, and more particularly to a pigment-based black ink containing a cabron black pigment dispersions and a macromolecular chromophores (MMCs) pigment.

2. Background of the Invention

Ink-jet printing technology has been developed for many years. The advantages include low price, low noise, and good full-color printing quality. Also, various substrates including plain paper, paper for special printing, and transparency can be printed.

Ink-jet printing is a non-contact method that involves ejecting ink droplets onto a recording substrate. For color ink-jet printing, suitable ink must meet the following requirements:

(1) Ink used has no feathering or bleeding.

(2) Ink used dries very fast.

(3) Printing nozzles do not generate clog.

(4) The ink used must have good storage stability.

(5) The ink used must be non-toxic.

Generally, few inks can meet the above requirements. For example, ink that dries very fast and has no bleeding will easily cause clogging on the printing nozzles.

Generally, four kinds of ink are required for a color inkjet printing machine, that is, magenta ink, cyan ink, yellow ink, and black ink. Most ink uses water-based dye. In recent years, light magenta, light cyan, light yellow, light black, orange, blue, and red inks have been developed for use in ink-jet printing, providing more plentiful color. Each can include at least one water-based dye, water, an organic solvent and other additives. However, such water-based dye ink exhibits very poor waterfastness and light resistance after printing.

Therefore, many pigment-based inks have been developed in recent years. A pigment-based ink includes at least one pigment, water, an organic solvent, and other additives, and exhibits better waterfastness and light resistance than a water soluble dye-based ink. A suitable dispersant and adhesive must be added to pigment-based ink. Moreover, pigment has a larger particle size, which easily precipitates and coagulates. This causes clogging on printing nozzles and lowers the printing quality. In order to combat this problem, it is required to decrease the coagulation force of the pigment particles by adding a surfactant such as resinous material or amine, and the solutions are called carbon black pigment dispersions.

U.S. Pat. No. 5,749,952 and U.S. Pat. No. 5,830,265 disclose a novel inkjet ink colorant, macromolecular chromophores (MMCs), which is a self-dispersing pigment. Such colorant is provided by Cabot and Orient companies. A general pigment is modified via chemical modification or ion exchange process to form cationic or anionic chromophores. Taking chemical modification as an example, carboxylate functionalities (COO⁻) or sulfonate functionalities (SO₃⁻) are introduced onto the surface of a general pigment to form a pigment having anionic functionalities on the surface, called anionic chromophores. Moreover, ammonium functionalities or phosphonium functionalities are introduced onto the surface of a general pigment to form a pigment having cationic functionalities on the surface, called cationic chromophores.

Hewlett-Packard, in U.S. Pat. No. 5,891,934 uses a chemical modified MMCs and a zwitterionic surfactant to increase the waterfastness of an ink. Hewlett-Packard, in U.S. Pat. No. 6,034,153 finds that an ink containing a partially chemically modified MMCs has better waterfastness than an ink containing a completely chemically modified MMCs pigment. Canon, in European Patent No. 1,167,470 discloses an ink including an MMCs pigment and a benzylmethacrylate dispersant.

However, in the above conventional technology, no one has ever disclosed a way of improving the optical density of an MMCs pigment-containing black ink.

### SUMMARY OF THE INVENTION

One object of the present invention is to provide a pigment-based black ink with high optical density. The ink of the present invention that combines a carbon black pigment and a macromolecular chromophores (MMCs) pigment has a higher optical density than ink singly using only carbon black pigment dispersions or MMCs.

Another object of the present invention is to provide a pigment-based black ink with excellent water resistance, and bleed and smear resistance.

A further object of the present invention is to provide an inkjet printing method for increasing optical density of an ink.

To achieve the above-mentioned objects, the pigment-based black ink of the present invention includes a carbon black pigment dispersions and a macromolecular chromophores (MMCs); and an aqueous solution medium.

According to a preferred embodiment of the present invention, in the pigment-based black ink of the present invention, the carbon black pigment dispersions is present in an amount of x weight%, the MMCs is present in an amount of y weight%, x is between 0.01 and 10, and y is between 0.01 and 10, both based on the total weight of the pigment-based black ink. Moreover, the pigment-based black ink of the present invention has a higher optical density than ink containing (x+y) weight % of the carbon black pigment dispersions and containing no MMCs, and also, than ink containing (x+y) weight % of MMCs and containing no carbon black pigment disersions.

According to the present invention, the inkjet printing method for increasing optical density of an ink includes the following steps. First, a pigment-based black ink is provided. The pigment-based black ink contains a carbon black pigment dispersions and a macromolecular chromophores (MMCs); and an aqueous solution medium. Then, the pigment-based black ink is inkjet printed onto a recording substrate.

### BRIEF DESCRIPTION OF THE DRAWING

FIG. 1 is a printed paper showing the black ink lines bleeding into the yellow ink background according to the ink composition of Examples 1 to 7 and Comparative Examples 1 to 4 of the present invention.

### DETAILED DESCRIPTION OF THE INVENTION

The pigment-based black ink of the present invention includes two kinds of pigment and an aqueous solution medium. The two kinds of pigment are a carbon black pigment dispersions and a macromolecular chromophores (MMCs). The present invention combines these two pigments for the first time and finds that ink including these two pigments has a higher optical density than ink including only carbon black pigment dispersions or MMCs alone. The pigment-based black ink of the present invention can be used in inkjet printing. In addition to high optical density, the ink of the present invention exhibits good waterfastness, bleed and smear resistance, and high printing quality.

According to the present invention, the weight ratio of the carbon black pigment dispersions to macromolecular chromophores (MMCs) can be between 1:5 and 5:1, preferably between 1:2 and 2:1. The carbon black pigment dispersions and MMCs can have a particle size of less than 1 μm, preferably 0.1 to 0.5 μm. The carbon black pigment dispersions can be present in an amount of 0.01 to 10 weight %., and the MMCs can be present in an amount of 0.01 to 10 weight %, both based on the total weight of the black ink.

According to a preferred embodiment of the present invention, in the pigment-based black ink of the present invention, the carbon black pigment dispersions is present in an amount of x weight %, the MMCs is present in an amount of y weight %, x is between 0.01 and 10, y is between 0.01 and 10, both based on the total weight of the pigment-based black ink. Moreover, the pigment-based black ink of the present invention has a higher optical density than ink containing (x+y) weight % of the carbon black pigment dispersions and containing no MMCs, and also, than ink containing (x+y) weight % of MMCs and containing no carbon black pigment dispersions.

According to the present invention, the main component of the aqueous solution medium is water. In addition to water, the aqueous solution medium can further include an organic solvent, surfactant, pH buffer solution, chelating agent, biocide, humectant, preservative, or UV-blocker. For example, the organic solvent can be present in an amount of 0.1 to 20 weight %, the surfactant can be present in amount of 0 to 30 weight %, the humectant can be present in an amount of 0.1 to 30 weight %, based on the total weight of the aqueous solution medium.

Carbon black pigment dispersions suitable for use in the present invention can be Bayer VPSP 20016 from Bayer, Bayer VPSP 20046 from Bayer, AcryJet series from Rohm & Haas, BASF 50087194 from BASF, BASF 50007212 from BASF, Ciba B-PI from Ciba, Ciba C-WA form Ciba, Sum Chemical 3107 from Sum Chemical, Hostafine series from Clariant, Ilford 1007-K from Ilford, MicroPigmo-series from Orient.

MMCs suitable for use in the present invention is not limited and can comprise anionic or cationic chromophores. Anionic chromophores have anionic functionalities such as carboxylate (COO⁻) or sulfonate (SO₃⁻) on the surface. Cationic chromophores have cationic functionalities such as ammonium functionalities (NR₄⁺) or phosphonium functionalities (PR₄⁺) on the surface. Representative examples of MMCs include Cab-O-Jet series (200 from Cabot, Cab-O-Jet 300) from Cabot, BonJet CW-series (CW-1 from Orient, CW-2 form Orient). Surfactants suitable for use in the present invention can be A-102 from CYTEC, LF-4 from CYTEC, 1, 3-BG from KYOWA, OG from KYOWA, BEPG from KYOWA, PD-9 from KYOWA, EP-810 from AIR PRODUCT, 1,6-hexandiol, 2,4,7,9-tetramethyl-5-decyne-4,7-diol, 1,1, 1-trimethylolpropane, CT-141 from AIR PRODUCT, CT-151 from AIR PRODUCT, OT-75 from CYTEC, GPG from CYTEC, OT-70PG from CYTEC, polyethandiol, polypropandiol, EO/PO copolymer, BO/EO copolymer, sodium dioctyl sulfosuccinate, alkylene oxide adduct of acetylene glycol, polybutyl resin, cellulose derivative, styrene/acrylic copolymer resin, maleic acid/styrene copolymer, or a polymer containing hydrophilic segments and hydrophobic segments.

The pH buffer solution suitable for use in the present invention can be diethanolamine, triethanolamine, hydroxides of alkali metals such as lithium hydroxide, sodium hydroxide and potassium hydroxide, ammonium hydroxide, and carbonates of alkali metals such as lithium carbonate, sodium carbonate and potassium carbonate.

Chelating agents suitable for use in the present invention can be sodium ethylenediaminetetraacetate, trisodium nitrilotriacetate, hydroxyethyl ethylenediamine trisodium acetate, diethylenetriamino pentasodium acetate, or uramil disodium acetate.

Organic solvents suitable for use in the present invention can be cyclohexane, methanol, ethanol, 2-propanol, ethylene glycol, diethylene glycol, triethylene glycol, propylene glycol, butylenes glycol, pentylene glycol, 2-pyrrolidone, or N-methyl-2-pyrrolidone.

The following examples are intended to illustrate the process and the advantages of the present invention more fully without limiting its scope, since numerous modifications and variations will be apparent to those skilled in the art.

### EXAMPLE 1

An ink composition was prepared by mixing the following components.

(1) 2 wt % of AcryJet Black 357 available from Rohm & Haas

(2) 4 wt % of BonJet CW-2 available from Orient

(3) 4.8 wt % of N-methyl-2-pyrrolidone available from Aldrich

(4) 5.8 wt % of trimethylol propane available from Aldrich

(5) 2 wt % of PEG 600 available from Dow

(6) 0.9 wt % of 1,6-hexanediol available from Aldrich

(7) 0.5 wt % GXL available from ICI

(8) deionized water

### EXAMPLE 2

An ink composition was prepared by mixing the following components.

(1) 3 wt % of AcryJet Black 357 available from Rohm & Haas

(2) 3 wt % of BonJet CW-2 available from Orient

(3) 4.8 wt % of N-methyl-2-pyrrolidone available from Aldrich

(4) 5.8 wt % of trimethylol propane available from Aldrich

(5) 2 wt % of PEG 600 available from Dow

(6) 0.9 wt % of 1,6-hexanediol available from Aldrich

(7) 0.5 wt % GXL available from ICI

(8) deionized water

### EXAMPLE 3

An ink composition was prepared by mixing the following components.

(1) 4 wt % of AcryJet Black 357 available from Rohm & Haas

(2) 2 wt % of BonJet CW-2 available from Orient

(3) 4.8 wt % of N-methyl-2-pyrrolidone available from Aldrich

(4) 5.8 wt % of trimethylol propane available from Aldrich

(5) 2 wt % of PEG 600 available from Dow

(6) 0.9 wt % of 1,6-hexanediol available from Aldrich

(7) 0.5 wt % GXL available from ICI

(8) deionized water

### EXAMPLE 4

An ink composition was prepared by mixing the following components.

(1) 2 wt % of Bayer VPSP 20016 available from Bayer

(2) 4 wt % of Cab-O-Jet 200 available from Cabot

(3) 4.8 wt % of N-methyl-2-pyrrolidone available from Aldrich

(4) 5.8 wt % of trimethylol propane available from Aldrich

(5) 2 wt % of PEG 600 available from Dow

(6) 0.9 wt % of 1,6-hexanediol available from Aldrich

(7) 0.5 wt % GXL available from ICI

(8) deionized water

### EXAMPLE 5

An ink composition was prepared by mixing the following components.

(1) 3 wt % of Bayer VPSP 20016 available from Bayer

(2) 3 wt % of Cab-O-Jet 200 available from Cabot

(3) 4.8 wt % of N-methyl-2-pyrrolidone available from Aldrich

(4) 5.8 wt % of trimethylol propane available from Aldrich

(5) 2 wt % of PEG 600 available from Dow

(6) 0.9 wt % of 1,6-hexanediol available from Aldrich

(7) 0.5 wt % GXL available from ICI

(8) deionized water

### EXAMPLE 6

An ink composition was prepared by mixing the following components.

(1) 4 wt % of Bayer VPSP 20016 available from Bayer

(2) 2 wt % of Cab-O-Jet 200 available from Cabot

(3) 4.8 wt % of N-methyl-2-pyrrolidone available from Aldrich

(4) 5.8 wt % of trimethylol propane available from Aldrich

(5) 2 wt % of PEG 600 available from Dow

(6) 0.9 wt % of 1,6-hexanediol available from Aldrich

(7) 0.5 wt % GXL available from ICI

(8) deionized water

### EXAMPLE 7

An ink composition was prepared by mixing the following components.

(1) 3 wt % of Bayer VPSP 20016 available from Bayer

(2) 3 wt % of BonJet CW-2 available from Orient

(3) 4.8 wt % of N-methyl-2-pyrrolidone available from Aldrich

(4) 5.8 wt % of trimethylol propane available from Aldrich

(5) 2 wt % of PEG 600 available from Dow

(6) 0.9 wt % of 1,6-hexanediol available from Aldrich

(7) 0.5 wt % GXL available from ICI

(8) deionized water

### COMPARATIVE EXAMPLE 1

An ink composition was prepared by mixing the following components.

(1) 6 wt % of AcryJet Black 357 available from Rohm & Haas

(2) 4.8 wt % of N-methyl-2-pyrrolidone available from Aldrich

(3) 5.8 wt % of trimethylol propane available from Aldrich

(4) 2 wt % of PEG 600 available from Dow

(5) 0.9 wt % of 1,6-hexanediol available from Aldrich

(6) 0.5 wt % GXL available from ICI

(7) deionized water

### COMPARATIVE EXAMPLE 2

An ink composition was prepared by mixing the following components.

(1) 6 wt % of BonJet CW-2 available from Orient

(2) 4.8 wt % of N-methyl-2-pyrrolidone available from Aldrich

(3) 5.8 wt % of trimethylol propane available from Aldrich

(4) 2 wt % of PEG 600 available from Dow

(5) 0.9 wt % of 1,6-hexanediol available from Aldrich

(6) 0.5 wt % GXL available from ICI

(7) deionized water

### COMPARATIVE EXAMPLE 3

An ink composition was prepared by mixing the following components.

(1) 6 wt % of Bayer VPSP 20016 available from Bayer

(2) 4.8 wt % of N-methyl-2-pyrrolidone available from Aldrich

(3) 5.8 wt % of trimethylol propane available from Aldrich

(4) 2 wt % of PEG 600 available from Dow

(5) 0.9 wt % of 1,6-hexanediol available from Aldrich

(6) 0.5 wt % GXL available from ICI

(7) deionized water

### COMPARATIVE EXAMPLE 4

An ink composition was prepared by mixing the following components.

(1) 6 wt % of Cab-O-Jet 200 available from Cabot

(2) 4.8 wt % of N-methyl-2-pyrrolidone available from Aldrich

(3) 5.8 wt % of trimethylol propane available from Aldrich

(4) 2 wt % of PEG 600 available from Dow

(5) 0.9 wt % of 1,6-hexanediol available from Aldrich

(6) 0.5 wt % GXL available from ICI

(7) deionized water

Printing

Each of the above ink compositions (from Examples and Comparative Examples) was printed onto a commercially available plain paper (70 gsm) in a commercially available inkjet printer (HP DeskJet 930C).

Testing Method

(1) Optical density: The black image after inkjet printing was examined with a spectrophotometer (GretagMacbeth Spectroscan) foroptical density. The results are shown in Table 1.

(2) Waterfastness: The black image after inkjet printing was first measured for optical density and then immersed in deionized water for 30 minutes of washing, removed, dried in the condition of room temperature, and measured again for optical density. ΔOD was calculated. The results are shown in Table 1.

(3) Smear resistance: A commercially available fluorescent pen (Pentel S512) was used to write on the black image after inkjet printing. The black pigment amount carried by the fluorescent pen was measured to determine the smear resistance of the black image. The results are shown in Table 1.

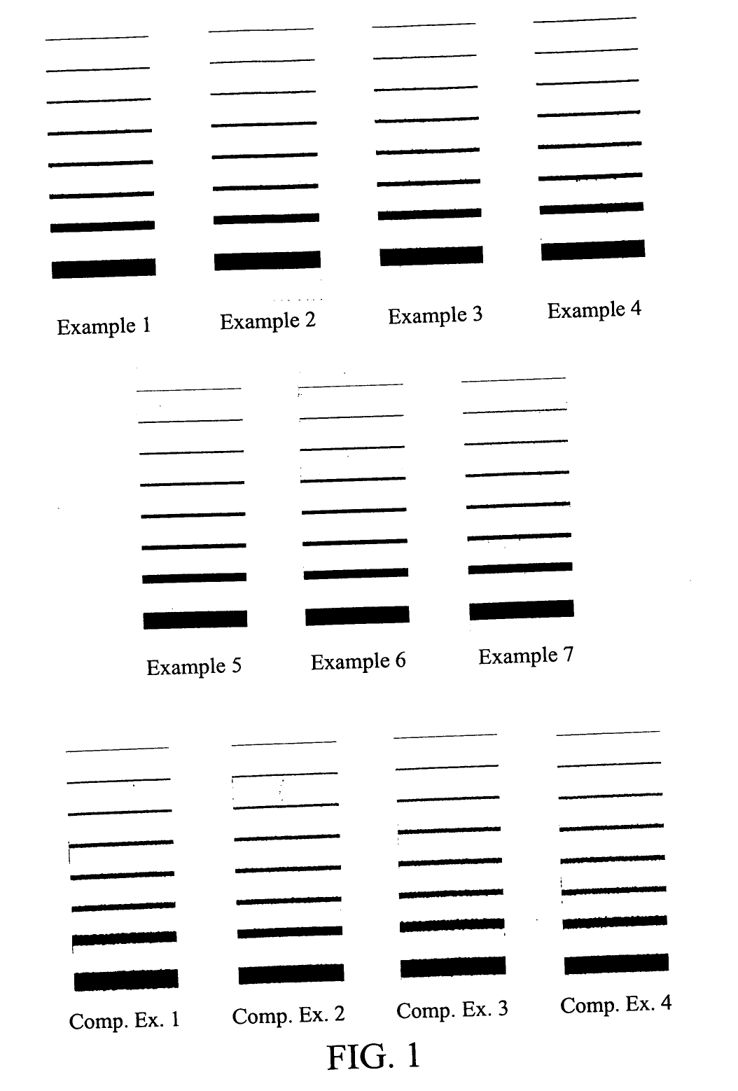

(4) Bleeding: A paper with yellow ink background was subjected to inkjet printing with each of the above black ink compositions (from Example and Comparative Examples) in the form of lines and was then observed for bleeding between yellow and black. The results are shown in FIG. 1 and Table 1.

TABLE 1

| | Carbon black | | | | | | | | | | |
|---|---|---|---|---|---|---|---|---|---|---|---|
| | pigment | | | | Mixed | | | | | | |
| | dispersions | | MMCs | | (Carbon black pigment | | | | | | |
| | Comp. | Comp. | Comp. | Comp. | dispersions + MMCs) | | | | | | |
| | Ex. | Ex. | Ex. | Ex. | Ex. | Ex. | Ex. | Ex. | Ex. | Ex. | Ex. |
| | 1 | 3 | 2 | 4 | 1 | 2 | 3 | 4 | 5 | 6 | 7 |
| Optical | 1.04 | 1.14 | 1.30 | 1.26 | 1.42 | 1.39 | 1.38 | 1.34 | 1.34 | 1.34 | 1.35 |
| density | | | | | | | | | | | |
| Water- | ⊚ | ⊚ | ◯ | X | ◯ | ◯ | ◯ | Δ | ◯ | ⊚ | ◯ |
| fastness | | | | | | | | | | | |
| Smear | ◯ | ◯ | X | X | Δ | ◯ | ◯ | Δ | ◯ | ◯ | ◯ |
| resistance | | | | | | | | | | | |
| Bleeding | X | X | ⊚ | Δ | ⊚ | ⊚ | ⊚ | ◯ | Δ | Δ | ⊚ |

※ (1) Waterfastness:
⊚: ΔOD = 0.
◯: ΔODl = 1˜5.
Δ: ΔOD = 6˜10.
X: ΔOD > 11.
(2) Smear resistance:
◯: the fluorescent line carries little black pigment.
Δ: the fluorescent line carries black pigment.
X: all of the fluorescent line is black pigment.
(3) Bleeding:
⊚: no bleeding.
◯: slight bleeding.
Δ: bleeding.
X: excessive bleeding.

It can be seen from the above experimental results that when an equal amount (6 weight %) of pigment is added, the ink of the present invention, containing both carbon black pigment dispersions and MMCs, has a higher optical density than ink containing only carbon black pigment dispersions or MMCs. Moreover, the ink of the present invention has excellent waterfastness, bleed- and smear-resistance, and high printing quality.

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A pigment-based black ink, comprising:
at least one carbon black pigment dispersions and at least one macromolecular chromophores (MMCs); and
an aqueous solution medium.

2. The pigment-based black ink as claimed in claim 1, wherein the weight ratio of the carbon black pigment dispersions to macromolecular chromophores (MMCs) is between 1:5 and 5:1.

3. The pigment-based black ink as claimed in claim 2, wherein the weight ratio of the carbon black pigment dispersions tomacromolecular chromophores (MMCs) is between 1:2 and 2:1.

4. The pigment-based black ink as claimed in claim 1, wherein the carbon black pigment dispersions has a particle size of less than 1 μm.

5. The pigment-based black ink as claimed in claim 1, wherein the macromolecular chromophores (MMCs) has a particle size of less than 1 μm.

6. The pigment-based black ink as claimed in claim 1, wherein the carbon black pigment dispersions is present in an amount of 0.01 to 10 weight %.

7. The pigment-based black ink as claimed in claim 1, wherein the macromolecular chromophores (MMCs) is present in an amount of 0.01 to 10 weight %.

8. The pigment-based black ink as claimed in claim 1, wherein the macromolecular chromophores (MMCS) is anionic.

9. The pigment-based black ink as claimed in claim 8, wherein the macromolecular chromophores (MMCs) contains carboxylate, sulfonate, or a combination thereof.

10. The pigment-based black ink as claimed in claim 1, wherein the medium further contains an additive, the additive comprises one of an organic solvent, surfactant, pH buffer solution, chelating agent, biocide, humectant, preservative, and UV-blocker.

11. The pigment-based black ink as claimed in claim 10, wherein the medium contains 0.1 to 20 weight % of an organic solvent.

12. The pigment-based black ink as claimed in claim 10, wherein the medium contains 0 to 30 weight % of a surfactant.

13. The pigment-based black ink as claimed in claim 10, wherein the medium contains 0.1 to 30 weight % of a humectant.

14. The pigment-based black ink as claimed in claim 1, wherein the carbon black pigment dispersions is present in an amount of x weight %, the MMCs is present in an amount of y weight %, x is between 0.01 and 10, y is between 0.01 and 10, both based on the total weight of the pigment-based black ink,
wherein the pigment-based black ink has a higher optical density than ink containing (x+y) weight % of the carbon black pigment dispersions and containing no MMCs, and wherein the pigment-based black ink has a higher optical density than ink containing (x+y) weight % of MMCs and containing no carbon black pigment dispersions.

15. The pigment-based black ink as claimed in claim 14, wherein the weight ratio of the carbon black pigment dispersions to the MMCs is between 1:5 and 5:1.

16. The pigment-based black ink as claimed in claim 15, wherein the weight ratio of the carbon black pigment dispersions to the MMCs is between 1:2 and 2:1.

17. An inkjet printing method for increasing optical density of an ink, comprising:
(a) providing a pigment-based black ink, wherein the pigment-based black ink contains
at least one carbon black pigment dispersions and at least one macromolecular chromophores (MMCs); and
an aqueous solution medium; and
(b) inkjet printing the pigment-based black ink onto a recording substrate.

18. The method as claimed in claim 17, wherein the weight ratio of the carbon black pigment dispersions to the MMCs is between 1:5 and 5:1.

19. The method as claimed in claim 18, wherein the weight ratio of the carbon black pigment dispersions to the MMCs is between 1:2 and 2:1.

20. The method as claimed in claim 17, wherein the carbon black pigment dispersions has a particle size of less than 1 μm.

21. The method as claimed in claim 17, wherein the macromolecular chromophores (MMCs) has a particle size of less than 1 μm.

22. The method as claimed in claim 17, wherein the carbon black pigment dispersions is present in an amount of 0.01 to 10 weight %.

23. The method as claimed in claim 17, wherein the macromolecular chromophores (MMCs) is present in an amount of 0.01 to 10 weight %.

24. The method as claimed in claim 17, wherein the macromolecular chromophores (MMCs) is anionic.

25. The method as claimed in claim 24, wherein the macromolecular chromophores (MMCs) contains carboxylate, sulfonate, or a combination thereof.

26. The method as claimed in claim 17, wherein the carbon black pigment dispersions is present in an amount of x weight %, the macromolecular chromophores (MMCs) is present in an amount of y weight %, x is between 0.01 and 10, y is between 0.01 and 10, both based on the total weight of the pigment-based black ink,
wherein the pigment-based black ink has a higher optical density than ink containing (x+y) weight % of the carbon black pigment dispersions and containing no MMCs, and wherein the pigment-based black ink has a higher optical density than ink containing (x+y) weight % of MMCs and containing no carbon black pigment dispersions.

27. The method as claimed in claim 26, wherein the weight ratio of the carbon black pigment dispersions to the MMCs is between 1:5 and 5:1.

28. The method as claimed in claim 27, wherein the weight ratio of the carbon black pigment dispersions to the MMCs is between 1:2 and 2:1.
